(19) United States
(12) Patent Application Publication
(10) Pub. No.: US 2025/0286665 A1
(43) Pub. Date: Sep. 11, 2025

(54) ENHANCED PHYSICAL SIDELINK FEEDBACK CHANNEL (PSFCH) TRANSMISSION SCHEME FOR SIDELINK UNLICENSED

(71) Applicant: Nokia Technologies Oy, Espoo (FI)

(72) Inventors: Yong LIU, Shanghai (CN); Timo Erkki LUNTTILA, Espoo (FI); Ling YU, Kauniainen (FI); Renato Barbosa ABREU, Aalborg (DK); Nuno Manuel KIILERICH PRATAS, Gistrup (DK); Laura Luque SANCHEZ, Nibe (DK); Jianguo LIU, Shanghai (CN); Naizheng ZHENG, Beijing (CN); Torsten WILDSCHEK, Gloucestershire (GB); Vinh VAN PHAN, Oulu (FI)

(73) Assignee: Nokia Technologies Oy, Espoo (FI)

(21) Appl. No.: 18/858,933

(22) PCT Filed: Apr. 27, 2022
(86) PCT No.: PCT/CN2022/089548

§ 371 Date: Oct. 22, 2024

(51) Int. Cl. H04L 1/1829; H04L 1/1812; H04W 74/0808

(52) U.S. Cl. CPC H04L 1/1854; H04L 1/1812; H04W 74/0808

(57) ABSTRACT

Systems, methods, apparatuses, and computer program products for enhanced PSFCH transmission for SL-U are provided. One method may include decoding, by a receiving user equipment, a physical sidelink shared channel (PSSCH), and determining a physical sidelink feedback channel (PSFCH) resource for hybrid automatic repeat request (HARQ) feedback to the physical sidelink shared channel (PSSCH). The method may then include determining whether to transmit the hybrid automatic repeat request (HARQ) feedback with partial interlace or with full interlace based at least on whether channel occupancy time (COT) sharing is detected from a transmitting user equipment.

### FIELD

Some example embodiments may generally relate to communications including mobile or wireless telecommunication systems, such as Long Term Evolution (LTE) or fifth generation (5G) radio access technology or new radio (NR) access technology or 5G beyond (e.g., 6G) access technology, or other communications systems. For example, certain example embodiments may generally relate to systems and/or methods for enhanced physical sidelink feedback channel (PSFCH) transmission for sidelink unlicensed (SL-U).

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology, 5G beyond and/or sixth generation (6G) radio access technology. 5G wireless systems refer to the next generation (NG) of radio systems and network architecture. A 5G system may be mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 5G beyond or 6G is expected to support further use cases beyond current mobile use scenarios, such as virtual and augmented reality, artificial intelligence, instant communications, improved support of IoT, etc.

### SUMMARY

Some example embodiments may be directed to a method. The method may include decoding, by a receiving user equipment, a physical sidelink shared channel (PSSCH), determining a physical sidelink feedback channel (PSFCH) resource for hybrid automatic repeat request (HARQ) feedback to the physical sidelink shared channel (PSSCH), and determining whether to transmit the hybrid automatic repeat request (HARQ) feedback with partial interlace or with full interlace based at least on whether channel occupancy time (COT) sharing is detected from a transmitting user equipment.

In an embodiment, the determining of whether to transmit the hybrid automatic repeat request (HARQ) feedback with partial interlace or with full interlace may include: detecting that the channel occupancy time (COT) is shared from the transmitting user equipment (UE) and the physical sidelink feedback channel (PSFCH) resource is within the channel occupancy time (COT), and transmitting the hybrid automatic repeat request (HARQ) feedback with partial interlace.

In an embodiment, the determining of whether to transmit the hybrid automatic repeat request (HARQ) feedback with partial interlace or with full interlace may include: detecting that the channel occupancy time (COT) is not shared from the transmitting user equipment (UE), and deciding not to transmit on the physical sidelink feedback channel (PSFCH) resource.

In an embodiment, the determining of whether to transmit the hybrid automatic repeat request (HARQ) feedback with partial interlace or with full interlace may include: detecting that the channel occupancy time (COT) is not shared from the transmitting user equipment (UE), and transmitting the hybrid automatic repeat request (HARQ) feedback with full interlace. In an embodiment, the hybrid automatic repeat request (HARQ) feedback comprises no acknowledgement (NACK).

In an embodiment, the method may further include performing type 1 listen before talk (LBT) and, when the type 1 listen before talk (LBT) succeeds, transmitting the no acknowledgement (NACK) with full interlace.

In an embodiment, when it is decided not to transmit on the physical sidelink feedback channel (PSFCH) resource, the hybrid automatic repeat request (HARQ) feedback is transmitted via additional physical sidelink feedback channel (PSFCH) occasions, or the hybrid automatic repeat request (HARQ) feedback is piggy backed with a physical sidelink shared channel (PSSCH) to the transmitting user equipment (UE) via medium access control (MAC) control element (CE).

In an embodiment, the transmitting of the hybrid automatic repeat request (HARQ) feedback with partial interlace may include: transmitting the hybrid automatic repeat request (HARQ) feedback with partial interlace at a fixed number of interlaced physical resource blocks.

In an embodiment, the transmitting of the hybrid automatic repeat request (HARQ) feedback with partial interlace at the fixed number of interlaced physical resource blocks may include transmitting at M interlaced physical resource blocks that span at least 2 MHz, wherein M≥2.

In an embodiment, the transmitting of the hybrid automatic repeat request (HARQ) feedback with partial interlace may include transmitting the hybrid automatic repeat request (HARQ) feedback with partial interlace at an adaptive number of interlaced physical resource blocks.

In an embodiment, the transmitting of the hybrid automatic repeat request (HARQ) feedback with partial interlace at an adaptive number of interlaced physical resource blocks may include transmitting at Q interlaced physical resource blocks that span at least 2 MHz, wherein 2≤Q≤M, wherein M is a total number of interlaced physical resource blocks.

In an embodiment, the transmitting of the hybrid automatic repeat request (HARQ) feedback with partial interlace may include, when a bandwidth spanned by transmissions at two physical resource blocks is smaller than 2 MHz, inserting an empty physical resource block between the two physical resource blocks.

In an embodiment, the detecting that the channel occupancy time (COT) is shared may include: detecting at least one of physical sidelink control channel (PSCCH) or physical sidelink shared channel (PSSCH) transmission from the transmitting user equipment (UE) or from another transmitting user equipment (UE) in a same sidelink system and, based on the detecting, determining that implicit channel occupancy time (COT) is established.

Certain example embodiments may be directed to a method. The method may include decoding, by a receiving user equipment, a physical sidelink shared channel (PSSCH), determining unused physical sidelink feedback channel (PSFCH) resources associated with the physical sidelink shared channel (PSSCH), and transmitting physical sidelink feedback channels (PSFCHs) on the unused physical sidelink feedback channel (PSFCH) resources. The physical sidelink feedback channels (PSFCHs) convey hybrid automatic repeat request (HARQ) feedback to the physical sidelink shared channel (PSSCH) or convey hybrid automatic repeat request (HARQ) feedbacks to previous physical sidelink shared channels (PSSCHs) from a transmitting user equipment.

Certain example embodiments may be directed to a method. The method may include decoding, by a receiving user equipment, a physical sidelink shared channel (PSSCH) occupying multiple sub-channels, determining D physical resource blocks of physical sidelink feedback channel (PSFCH) resources associated with the physical sidelink shared channel (PSSCH), and transmitting at Q physical resource blocks that span at least 2 MHz, wherein 2≤Q≤D.

Some example embodiments may be directed to an apparatus including at least one processor and at least one memory comprising computer program code. The at least one memory and computer program code are configured, with the at least one processor, to cause the apparatus at least to decode a physical sidelink shared channel (PSSCH), to determine a physical sidelink feedback channel (PSFCH) resource for hybrid automatic repeat request (HARQ) feedback to the physical sidelink shared channel (PSSCH), and to determine whether to transmit the hybrid automatic repeat request (HARQ) feedback with partial interlace or with full interlace based at least on whether channel occupancy time (COT) sharing is detected from a transmitting user equipment.

In an embodiment, to determine whether to transmit the hybrid automatic repeat request (HARQ) feedback with partial interlace or with full interlace, the apparatus may be caused to: detect that the channel occupancy time (COT) is shared from the transmitting user equipment (UE) and the physical sidelink feedback channel (PSFCH) resource is within the channel occupancy time (COT), and transmitting the hybrid automatic repeat request (HARQ) feedback with partial interlace.

In an embodiment, to determine whether to transmit the hybrid automatic repeat request (HARQ) feedback with partial interlace or with full interlace, the apparatus may be caused to: detect that the channel occupancy time (COT) is not shared from the transmitting user equipment (UE), and decide not to transmit on the physical sidelink feedback channel (PSFCH) resource.

In an embodiment, to determine whether to transmit the hybrid automatic repeat request (HARQ) feedback with partial interlace or with full interlace, the apparatus may be caused to: detect that the channel occupancy time (COT) is not shared from the transmitting user equipment (UE), and transmit the hybrid automatic repeat request (HARQ) feedback with full interlace. In an embodiment, the hybrid automatic repeat request (HARQ) feedback comprises no acknowledgement (NACK).

In an embodiment, the apparatus may be caused to perform type 1 listen before talk (LBT) and, when the type 1 listen before talk (LBT) succeeds, transmit the no acknowledgement (NACK) with full interlace.

In an embodiment, when it is decided not to transmit on the physical sidelink feedback channel (PSFCH) resource, the hybrid automatic repeat request (HARQ) feedback is transmitted via additional physical sidelink feedback channel (PSFCH) occasions, or the hybrid automatic repeat request (HARQ) feedback is piggy backed with a physical sidelink shared channel (PSSCH) to the transmitting user equipment (UE) via medium access control (MAC) control element (CE).

In an embodiment, to transmit the hybrid automatic repeat request (HARQ) feedback with partial interlace, the apparatus may be caused to transmit the hybrid automatic repeat request (HARQ) feedback with partial interlace at a fixed number of interlaced physical resource blocks.

In an embodiment, to transmit the hybrid automatic repeat request (HARQ) feedback with partial interlace at the fixed number of interlaced physical resource blocks, the apparatus may be caused to transmit at M interlaced physical resource blocks that span at least 2 MHz, wherein M≥2.

In an embodiment, to transmit the hybrid automatic repeat request (HARQ) feedback with partial interlace, the apparatus may be caused to transmit the hybrid automatic repeat request (HARQ) feedback with partial interlace at an adaptive number of interlaced physical resource blocks.

In an embodiment, to transmit the hybrid automatic repeat request (HARQ) feedback with partial interlace at an adaptive number of interlaced physical resource blocks, the apparatus may be caused to transmit at Q interlaced physical resource blocks that span at least 2 MHz, wherein 2≤Q≤M, wherein M is a total number of interlaced physical resource blocks.

In an embodiment, to transmit the hybrid automatic repeat request (HARQ) feedback with partial interlace, the apparatus may be caused to, when a bandwidth spanned by transmissions at two physical resource blocks is smaller than 2 MHz, insert an empty physical resource block between the two physical resource blocks.

In an embodiment, to detect that the channel occupancy time (COT) is shared, the apparatus may be caused to detect at least one of physical sidelink control channel (PSCCH) or physical sidelink shared channel (PSSCH) transmission from the transmitting user equipment (UE) or from another transmitting user equipment (UE) in a same sidelink system and, based on the detecting, determine that implicit channel occupancy time (COT) is established.

Certain example embodiments may be directed to an apparatus including at least one processor and at least one memory comprising computer program code. The at least one memory and computer program code are configured, with the at least one processor, to cause the apparatus at least to decode a physical sidelink shared channel (PSSCH), to determine unused physical sidelink feedback channel (PSFCH) resources associated with the physical sidelink shared channel (PSSCH), and to transmit physical sidelink feedback channels (PSFCHs) on the unused physical sidelink feedback channel (PSFCH) resources. The physical sidelink feedback channels (PSFCHs) convey hybrid automatic repeat request (HARQ) feedback to the physical sidelink shared channel (PSSCH) or convey hybrid automatic repeat request (HARQ) feedbacks to previous physical sidelink shared channels (PSSCHs) from a transmitting user equipment.

Certain example embodiments may be directed to an apparatus including at least one processor and at least one memory comprising computer program code. The at least one memory and computer program code are configured, with the at least one processor, to cause the apparatus at least to decode a physical sidelink shared channel (PSSCH) occupying multiple sub-channels, to determine D physical resource blocks of physical sidelink feedback channel (PSFCH) resources associated with the physical sidelink shared channel (PSSCH), and to transmit at Q physical resource blocks that span at least 2 MHz, wherein 2≤Q≤D.

Some example embodiments may be directed to an apparatus including means for decoding a physical sidelink shared channel (PSSCH), means for determining a physical sidelink feedback channel (PSFCH) resource for hybrid automatic repeat request (HARQ) feedback to the physical sidelink shared channel (PSSCH), and means for determining whether to transmit the hybrid automatic repeat request (HARQ) feedback with partial interlace or with full interlace based at least on whether channel occupancy time (COT) sharing is detected from a transmitting user equipment.

Certain example embodiments may be directed to an apparatus including means for decoding a physical sidelink shared channel (PSSCH), means for determining unused physical sidelink feedback channel (PSFCH) resources associated with the physical sidelink shared channel (PSSCH), and means for transmitting physical sidelink feedback channels (PSFCHs) on the unused physical sidelink feedback channel (PSFCH) resources. The physical sidelink feedback channels (PSFCHs) convey hybrid automatic repeat request (HARQ) feedback to the physical sidelink shared channel (PSSCH) or convey hybrid automatic repeat request (HARQ) feedbacks to previous physical sidelink shared channels (PSSCHs) from a transmitting user equipment.

Some example embodiments may be directed to an apparatus including means for decoding a physical sidelink shared channel (PSSCH) occupying multiple sub-channels, means for determining D physical resource blocks of physical sidelink feedback channel (PSFCH) resources associated with the physical sidelink shared channel (PSSCH), and means for transmitting at Q physical resource blocks that span at least 2 MHz, wherein 2≤Q≤D.

Some example embodiments may be directed to a computer readable medium. The computer readable medium may have program instructions stored thereon for performing a method that includes decoding a physical sidelink shared channel (PSSCH), determining a physical sidelink feedback channel (PSFCH) resource for hybrid automatic repeat request (HARQ) feedback to the physical sidelink shared channel (PSSCH), and determining whether to transmit the hybrid automatic repeat request (HARQ) feedback with partial interlace or with full interlace based at least on whether channel occupancy time (COT) sharing is detected from a transmitting user equipment.

Certain example embodiments may be directed to a computer readable medium. The computer readable medium may have program instructions stored thereon for performing a method that includes decoding a physical sidelink shared channel (PSSCH), determining unused physical sidelink feedback channel (PSFCH) resources associated with the physical sidelink shared channel (PSSCH), and transmitting physical sidelink feedback channels (PSFCHs) on the unused physical sidelink feedback channel (PSFCH) resources. The physical sidelink feedback channels (PSFCHs) convey hybrid automatic repeat request (HARQ) feedback to the physical sidelink shared channel (PSSCH) or convey hybrid automatic repeat request (HARQ) feedbacks to previous physical sidelink shared channels (PSSCHs) from a transmitting user equipment.

Certain example embodiments may be directed to a computer readable medium. The computer readable medium may have program instructions stored thereon for performing a method that includes decoding a physical sidelink shared channel (PSSCH) occupying multiple sub-channels, determining D physical resource blocks of physical sidelink feedback channel (PSFCH) resources associated with the physical sidelink shared channel (PSSCH), and transmitting at Q physical resource blocks that span at least 2 MHz, wherein 2≤Q≤D.

### BRIEF DESCRIPTION OF THE DRAWINGS:

For proper understanding of example embodiments, reference should be made to the accompanying drawings, wherein:

FIG. 1 illustrates an example of interlaced frequency division multiplexing (FDM) scheme for NR-unlicensed uplink;

FIG. 2 illustrates an example frame structure of a sidelink slot with PSFCH;

FIG. 3 illustrates an example mapping between PSSCHs and PSFCHs;

FIG. 4 illustrates an example of hybrid automatic repeat request (HARQ) feedback in full interlace to meet occupied channel bandwidth (OCB) requirement(s);

FIG. 5 illustrates an example of partial interlace or full interlace depending on channel occupancy time (COT) sharing, according to an embodiment;

FIG. 6 illustrates an example flow diagram of a method, according to an embodiment;

FIG. 7 illustrates an example partial interlace structure, according to an embodiment;

FIG. 8 illustrates an example adaptive partial interlace structure, according to an embodiment;

FIG. 9 illustrates an example partial interlace structure, according to an embodiment;

FIG. 10 illustrates an example partial interlace structure with PSFCH resource period 2, according to an embodiment;

FIG. 11 illustrates an example partial interlace structure with PSFCH resource period 4, according to an embodiment;

FIGS. 12A and 12B illustrate examples of PSFCH transmissions on unused PSFCH resources, according to an embodiment;

FIG. 13 illustrates an example of PSFCH transmissions on unused PSFCH resources from multiple PRB clusters, according to an embodiment;

FIG. 14 illustrates an example of an interlaced PSSCH, according to an embodiment;

FIG. 15 illustrates an example of Type 2A LBT before PSFCH symbols, according to an embodiment;

FIG. 16 illustrates an example of Type 2C LBT if guard symbol before PSFCH symbols is shortened, according to an embodiment; and

FIG. 17 illustrates an example system including multiple apparatuses, according to certain embodiments.

### DETAILED DESCRIPTION:

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for enhanced PSFCH transmission for SL-U, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

The scope of NR in unlicensed spectrum was limited to below 7 GHz bands, and there are certain occupied channel bandwidth (OCB) regulatory requirements in the unlicensed spectrum. For the frequency range (FR) below 7 GHz, there may be spectrum regulatory requirements for the design of uplink (UL) physical channels. For example, the European Telecommunications Standards Institute (ETSI) specifies that OCB should be between 80% and 100% of the declared nominal channel bandwidth. As per updated ETSI regulation, during a channel occupancy time (COT), equipment may operate temporarily with an OCB of less than 80% of its nominal channel bandwidth with a minimum of 2 MHz.

Regulations on the maximum power spectral density are typically stated with a resolution bandwidth of 1 MHz. For instance, the ETSI specification requires a maximum power spectral density (PSD) of 10 dBm/MHz for 5150-5350 MHz. As 10 KHz resolution is required for testing the 1 MHz PSD constraint, the maximum PSD constraint should be met in any occupied 1 MHz bandwidth. In addition, certain regulations may impose a band specific total maximum transmission power in terms of Effective Isotropic Radiated Power (EIRP). For example, ETSI has EIRP limit of 23 dBm for 5150-5350 MHz.

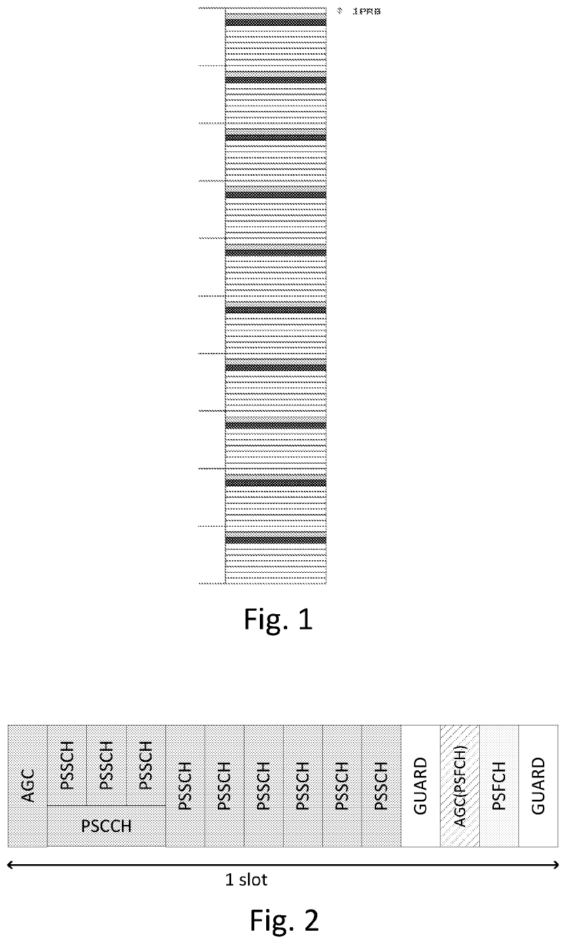

The regulatory limitations in terms of OCB and PSD guided the design choices for the uplink channels of NR-unlicensed system. The interlaced frequency division modulation (FDM) scheme for NR-U uplinkwas adopted, as shown in the example of FIG. 1.

In Third Generation Partnership Project (3GPP) Release-16, PSFCH for sidelink communication was specified to carry hybrid automatic repeat request (HARQ) feedback over the sidelink (at physical layer) from a UE that is an intended recipient of a physical sidelink shared channel (PSSCH) transmission (henceforth an Rx UE) to the UE which performed the transmission (henceforth a Tx UE).

PSFCH transmits a sequence in one physical resource block (PRB) repeated over two orthogonal frequency division multiplex (OFDM) symbols, the first of which can be used for automatic gain control (AGC), near the end of the sidelink resource in a slot. FIG. 2 illustrates an example of slot format of physical sidelink control channel (PSCCH), PSSCH, and PSFCH. The sequence as base sequence is (pre-)configured per sidelink resource pool.

The time resources for PSFCH are (pre-)configured to occur once in every 1, 2, or 4 slots. The HARQ feedback resource (PSFCH) is derived from the resource location of PSCCH/PSSCH.

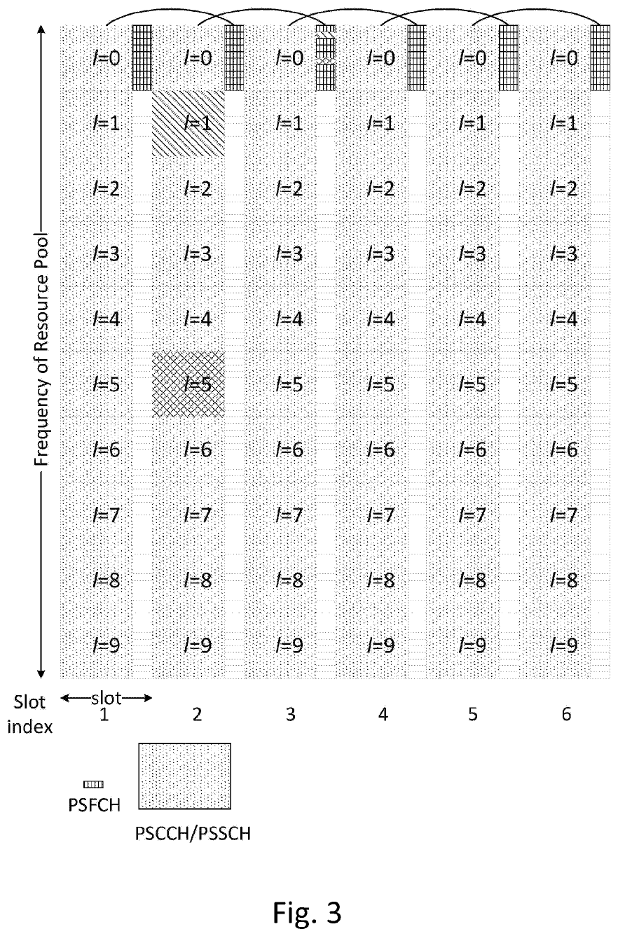

For PSSCH-to-HARQ timing, the gNB configures a parameter K with the unit of slot. The time occasion for PSFCH is determined from K. For a PSSCH transmission with its last symbol in slot n, HARQ feedback is in slot n+a where a is the smallest integer larger than or equal to K with the condition that slot n+a contains PSFCH resources. FIG. 3 illustrates an example mapping between PSSCHs and PSFCHs. In the example illustrated in FIG. 3, the period of PSFCH resources is configured as 1, and K is configured as 1. For a PSSCH transmitted in slot 2, the time occasion for the corresponding PSFCH is slot 3.

In view of the above, it would be advantageous to improve the HARQ feedback mechanism for NR sidelink communication, for example, in order to meet the OCB regulatory requirement in unlicensed spectrum.

Therefore, certain example embodiments described herein may provide an enhanced PSFCH transmission method for SL-U that can meet OCB requirements, and therefore can overcome at least the disadvantages described above. Thus, certain example embodiments discussed below are directed to improvements in computer-related technology.

A PSFCH transmission specified for licensed spectrum occupies just one PRB as shown in FIG. 3, which does not meet the OCB regulatory requirement in unlicensed spectrum, i.e., where OCB shall be between 80% and 100% of the declared NCB, or temporarily at least 2 MHz.

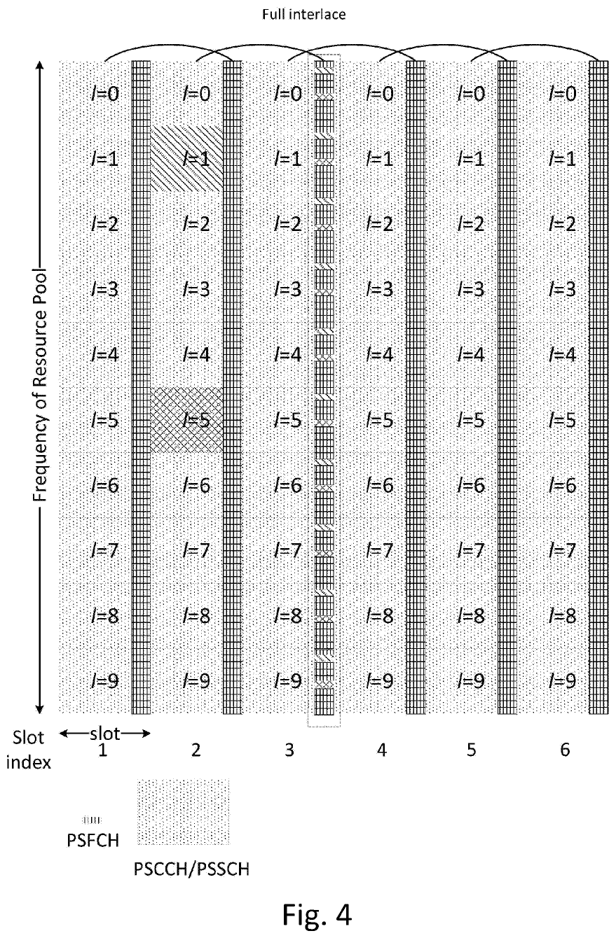

To meet the OCB regulatory requirement, one approach is to repeat PSFCHs multiple times (named full interlace) in frequency domain to occupy at least 80% of the declared Nominal Channel Bandwidth (e.g. 20 MHz), as shown in FIG. 4. However, this is not resource efficient. When the PSFCH period is long (e.g., 4 slots), there would not be enough PSFCH resources available in frequency domain to achieve this approach.

Therefore, certain example embodiments provide a resource efficient method at least to meet the OCB requirement in unlicensed spectrum such that the use of resources is optimized.

As introduced above, certain example embodiments provide an improved method of adaptive NR sidelink HARQ feedback in an unlicensed carrier that can meet OCB requirement. In an embodiment, when sharing a COT initiated by a Tx UE, an Rx UE may transmit HARQ feedback(s) on multiple interlaced PRBs that span at least 2 MHz (partial interlace), and can further transmit adaptively at a selected subset of the interlaced PRBs to flexibly achieve link adaptation and in the meantime reduce mutual interference. In the case of no COT sharing, according to an embodiment, the Rx UE can choose not to transmit HARQ feedback for resource efficiency, or only to feedback NACK using a full interlace to reduce mutual interference depending on gNB (pre)configuration or signalling from the corresponding Tx UE.

Some example embodiments can ensure that PSFCH transmissions meet OCB requirement resource efficiently, and increase reliability of HARQ feedbacks by reducing mutual interference.

Certain embodiments may include operations at a Rx UE to transmit HARQ feedback depending on (pre)configuration from gNB and/or signaling from the corresponding Tx UE. In one embodiment, partial interlace or full interlace PSFCH transmission may be selected depending on COT sharing. With full interlace for PSFCH transmission, a UE transmits on an interlace of PRBs which span between 80% and 100% of the declared NCB (e.g., span at least 16 MHz of 20 MHz). With partial interlace for PSFCH transmission, a UE transmits on at least two interlaced PRBs which span at least 2 MHz.

According to certain embodiments, an Rx UE decodes a PSSCH destined to it and determines the PSFCH resource for HARQ feedback to the PSSCH. If a COT is shared from the Tx UE and the PSFCH resource is within COT, the Rx UE transmits the HARQ feedback with partial interlace. Otherwise, the Rx UE transmits the HARQ feedback with full interlace.

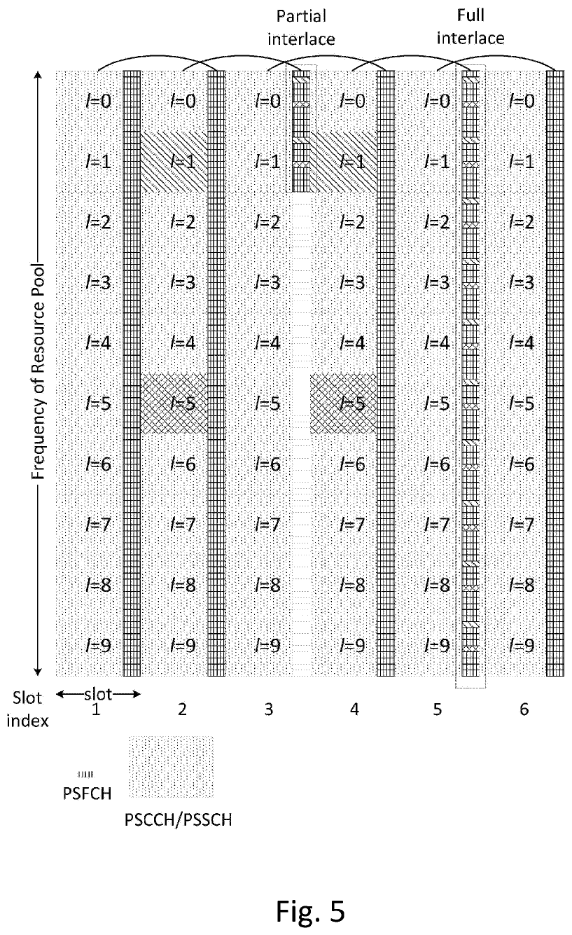

FIG. 5 illustrates an example of partial interlace or full interlace depending on COT sharing. In the example of FIG. 5, a COT is initiated by the Tx UE in slot 2 and lasts until the end of slot 3. The corresponding Rx UE transmits the HARQ feedback with partial interlace at the PSFCH symbols in slot 3.

In some embodiments, the gNB might only configure partial interlace mode, which may be due to capacity limitation of available PSFCH resources. This may be the case especially when the period of PSFCH resources is large (e.g. the period is 4).

According to certain embodiments, if a COT is shared by the Tx UE and the PSFCH resource is within the COT, the Rx UE may transmit PSFCH on a partial interlace. Otherwise, the Rx UE does not transmit PSFCH. The Rx UE can rely on other means for HARQ feedback (e.g., additional PSFCH occasions, the HARQ feedback is piggy backed with a PSSCH from the Rx UE to the Tx UE via a MAC CE). Thus, in an embodiment, there is no HARQ feedback with full interlace if no COT sharing. For the frame structure configuration with shortened empty symbol (guard symbol) before PSFCH symbols, COT sharing will be acquired most of the time.

In some embodiments, as an alternative, only NACK feedback is provided with full interlace if no COT sharing. According to this embodiment, if a COT is shared by the Tx UE and the PSFCH resource is within the COT, the Rx UE may transmit HARQ feedback with partial interlace. If there is no COT sharing by the Tx UE, the Rx UE might only transmit NACK on a full interlace. ACK feedback can rely on other means, e.g., additional PSFCH occasions, piggybacked with a PSSCH from the Rx UE, etc. Alternatively or additionally, a timer or the number of additional PFSCH occasions may be (pre-)configured for ACK. After the timer expires or additional PFSCH occasions have passed without NACK received, the Tx UE may determine ACK. This option can be especially suitable for low priority traffic. It can let the Rx UE not to transmit PSFCH in the case of no COT sharing to reduce mutual interference.

Sidelink control information (SCI) for the Tx UE can include signalling to indicate either no HARQ feedback or only-NACK feedback with full interlace, etc. Alternatively, these options can be (pre)configured at the system level by the gNB as part of the resource pool configuration.

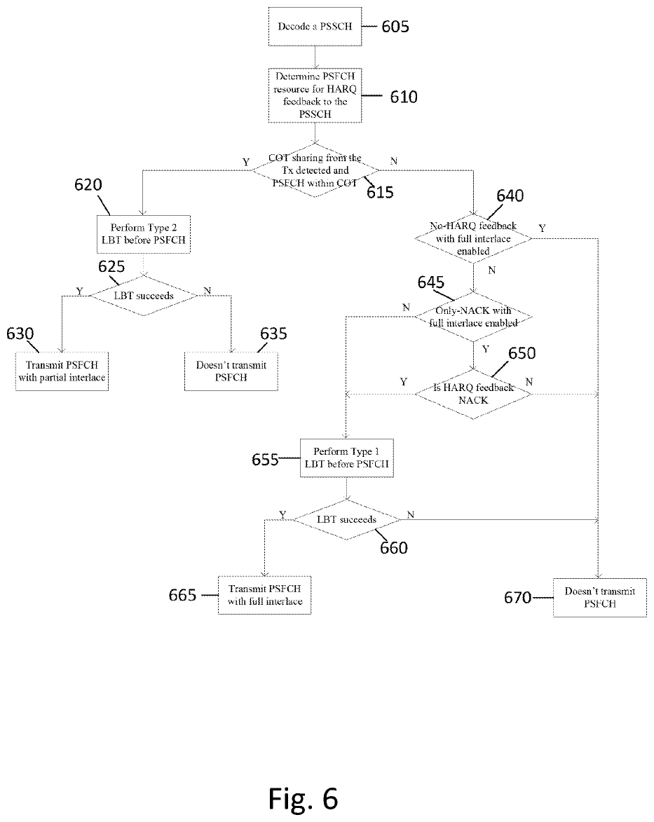

FIG. 6 illustrates an example flow diagram of a method depicting HARQ feedback, according to an example embodiment. In certain example embodiments, the flow diagram of FIG. 6 may be performed by a network entity or communication device in a communications system such as, but not limited to, LTE, 5G NR, or 5G beyond (e.g., 6G). For instance, in some example embodiments, the communication device performing the method of FIG. 6 may include a UE, sidelink (SL) UE, wireless device, mobile station, IoT device, UE type of roadside unit (RSU), a wireless transmit/receive unit, customer premises equipment (CPE), other mobile or stationary device, or the like. For instance, in certain example embodiments, the method of FIG. 6 may include procedures or operations performed by a Rx UE, as described or illustrated elsewhere herein. According to an embodiment, the method depicted in FIG. 6 may be performed or executed by apparatus 10 discussed below.

As illustrated in the example of FIG. 6, at 605, the Rx UE may decode a PSSCH and, at 610, may determine PSFCH resource for HARQ feedback to the PSSCH. At 615, the Rx UE may determine whether COT sharing from the Tx UE is detected and PSFCH within COT.

In certain embodiments, if COT sharing from the Tx UE is detected, then the method may include, at 620, the Rx UE performing Type 2 listen before talk (LBT) before PSFCH. At 625, it may be determined whether LBT succeeds. If LBT succeeds, then the method may include, at 630, the Rx UE transmitting PSFCH with partial interlace. If LBT does not succeed, then the method may include, at 635, not transmitting PSFCH. It is noted that operation to perform Type 2 LBT, as shown at 620 in FIG. 6, may be optional and the RX UE may omit it if certain conditions are fulfilled (e.g., gap between the end of TX UE's transmission and the start of PSFCH transmission by the RX UE is less than 16 microseconds).

According to certain embodiments, if COT sharing from the Tx UE is not detected at 615, then, at 640, it is determined whether no HARQ feedback with full interlace is enabled. If no HARQ feedback with full interlace is enabled, then PSFCH is not transmitted, as shown at 670. If it is determined that no HARQ feedback with full interlace is not enabled, then the method may include, at 645, determining if only NACK with full interlace is enabled. If it is determined that only NACK with full interlace is enabled, then the method may include, at 650, determining if HARQ feedback is NACK. If it is determined that HARQ feedback is not NACK, then PSFCH is not transmitted, as shown at 670. If it is determined that HARQ feedback is NACK, then the method may include, at 655, performing Type 1 LBT before PSFCH. If it is determined that LBT succeeds at 660, then the method may include, at 665, transmitting PSFCH with full interlace. If it is determined that LBT does not succeed at 660, then PSFCH is not transmitted, as shown at 670.

A partial interlace is defined as a subset of M PRBs of an interlace, where the interlace definition follows 3GPP Release-16 Uplink Type 2 resource allocation defined for NR-Unlicensed. As in Release-16, an interlace is comprised of 10 (or in some cases 11) physical resource blocks (PRBs). On a given 20 MHz unlicensed channel, there are 10 (with 15 kHz SCS) or 5 (with 30 kHz SCS) such interlaces. The PRBs of the partial interlace may be selected such that each partial interlace is comprised of M PRBs (e.g. 2), where the M PRBs are either: the neighboring PRBs of an interlace (e.g. #0 and #10; #20 and #30 . . . ), or separated as much as possible (e.g. #0 and #50; #10 and #60 . . . ).

There may be two alternatives for how to allocate the resources for different UEs. A first alternative is to allocate the PRBs that are as close to each other as possible, such that, e.g., with 15 kHz, if M=2 and N=10, the first 5 partial interlaces are e.g. PRBs [0&10; 1&11; 2&12; 3&13; 4&14]. Here, N corresponds to the number of SL sub-channels multiplied with the period of PSFCH resources.

A second alternative is to firstly allocate all PRBs of one interlace before taking resources from another interlace. With the example in the first alternative above, the first 5 partial interlaces are, e.g., PRBs [0&10; 20&30; 40&50; 60&70; 80&90].

The following description of partial interlace structure focuses on the option with the neighboring PRBs of an interlace as the M PRBs and the first alternative of resource allocation for different UEs. However, it is noted that this approach can also be applied to other options similarly.

More generally, the frequency band (S PRBs: PRB 1, 2, . . . , S) of PSFCH resources may be divided into multiple parts of same size. Each part is called a PRB cluster and occupies N consecutive PRBs, where N corresponds to the number of SL sub-channels multiplied with the period of PSFCH resources. An interlace may be comprised of PRBs with the same local index from PRB clusters. An interlace may include a PRB from each PRB cluster.

The PSFCH resource period is P (P: 1, 2, 4). Sub-channels in slot 1,2, . . . ,P (relative slot index) are mapped to PSFCH resources in the same slot. For a sub-channel w in slot p, the corresponding PSFCH resource for transmitting HARQ feedback is PRB_{p-1+w*P}(0<=w<=N/P−1).

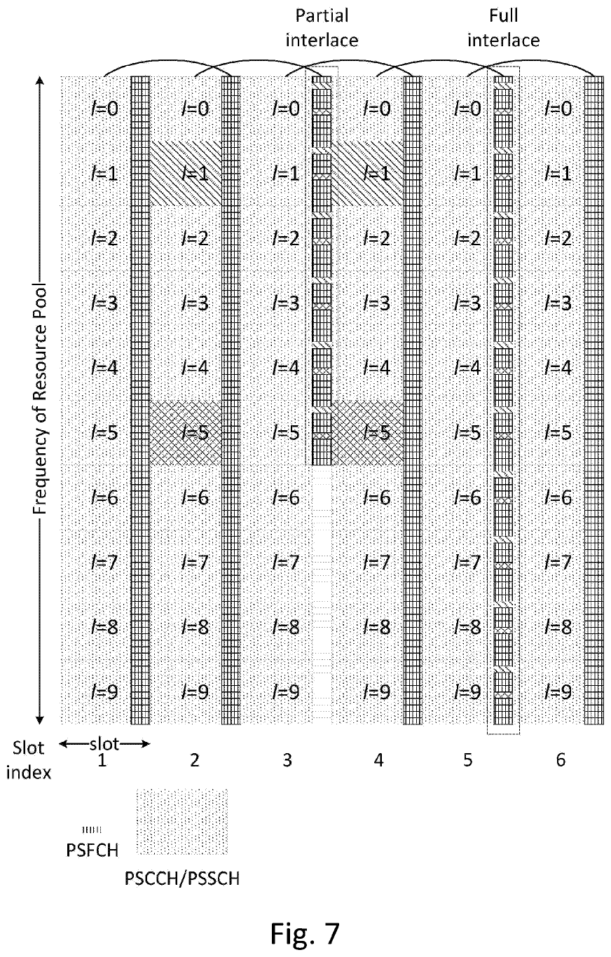

According to certain embodiments, HARQ feedback transmissions in partial interlace can be fixed or adaptive. For fixed HARQ feedback transmission, there may be a fixed number of interlaced PRBs for HARQ feedback transmission. For example, a UE may transmit at M (M≥2) interlaced PRBs which span at least 2 MHz. The enhancement, according to certain embodiments, can be achieved via repetition. PSFCHs for legacy sidelink system are repeated multiple times (M times) in frequency domain. If a Tx UE transmits in sub-channel w in slot p, the corresponding PSFCH resource for its Rx transmitting HARQ feedback are M PRBs (PRB_{p-1+w*P},PRB_{p-1+w*P+N}, . . . , PRB_{p-1+w*P+N*(M-1)}). As an example, if subcarrier spacing is 15 kHz, N=10, M=6, FIG. 7 illustrates an example of a partial interlace structure, according to certain embodiments. As another example, if subcarrier spacing is 15 kHz, N=10, M=2, a partial interlace structure is shown in FIG. 5 introduced above.

In some embodiments, PSFCHs may convey the HARQ feedback corresponding to the latest PSSCH from the transmitting UE. Alternatively, PSFCHs may convey both the HARQ feedback corresponding to the latest PSSCH and HARQ feedbacks corresponding to previous PSSCHs from the transmitting UE. In some embodiments, a PSFCH conveying a HARQ feedback occupies a PRB. Alternatively, multiple HARQ feedbacks may be jointly encoded and then transmitted at multiple PRBs.

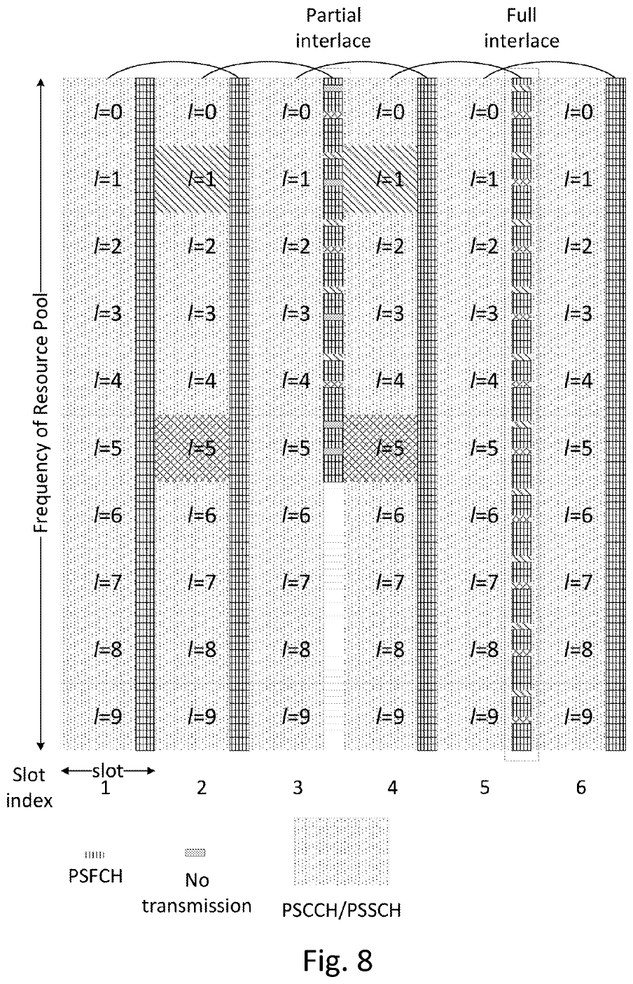

For adaptive HARQ feedback transmission, there may be an adaptive number of interlaced PRBs for HARQ feedback transmission. For example, out of M interlaced PRBs, a UE transmits at Q (2≤Q≤M) interlaced PRBs which span at least 2 MHz. The number of PRBs Q can be set based on the traffic priority and/or the buffered HARQ feedbacks. The selected Q PRBs may be uniformly distributed. The Q PRBs can be selected randomly to randomize mutual interference of PSFCH transmissions from different UEs. Alternatively, the Q PRBs can be selected to maximize total transmission power. FIG. 8 illustrates an example of an adaptive partial interlace structure, according to certain embodiments.

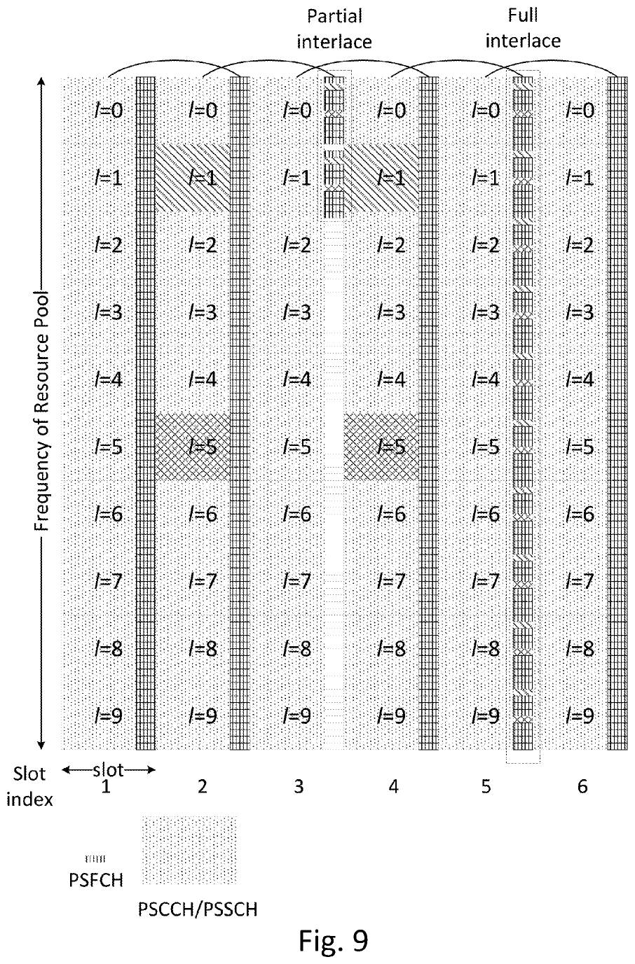

In the example of FIG. 5 discussed above, the bandwidth (1.98 MHz) spanned by transmissions at two PRBs is slightly smaller than 2 MHz. According to an embodiment, to strictly meet the 2 MHz regulatory requirement, an empty PRB can be inserted between the two repetitions, as shown in the partial interlace structure of FIG. 9.

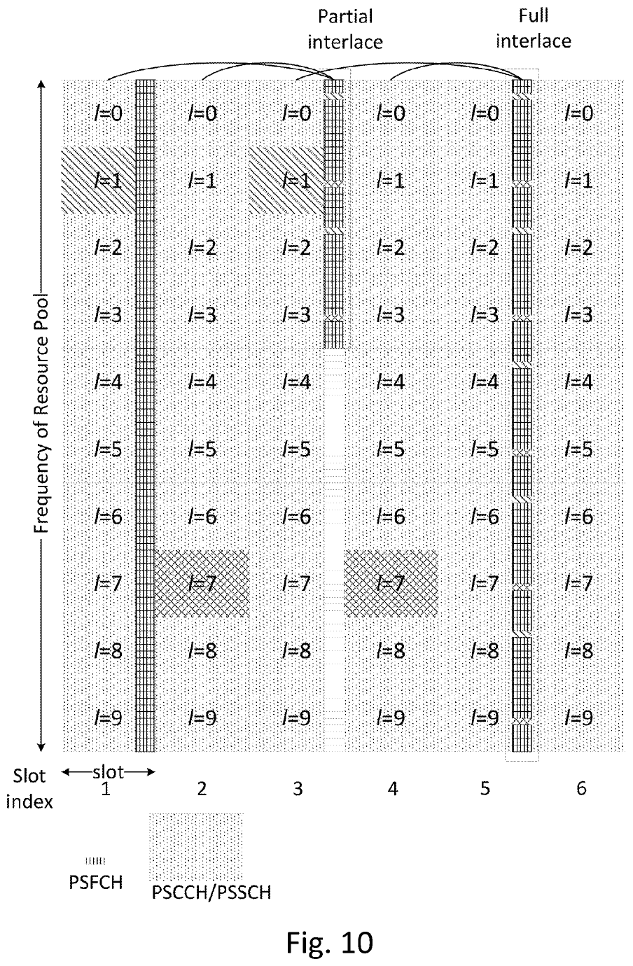

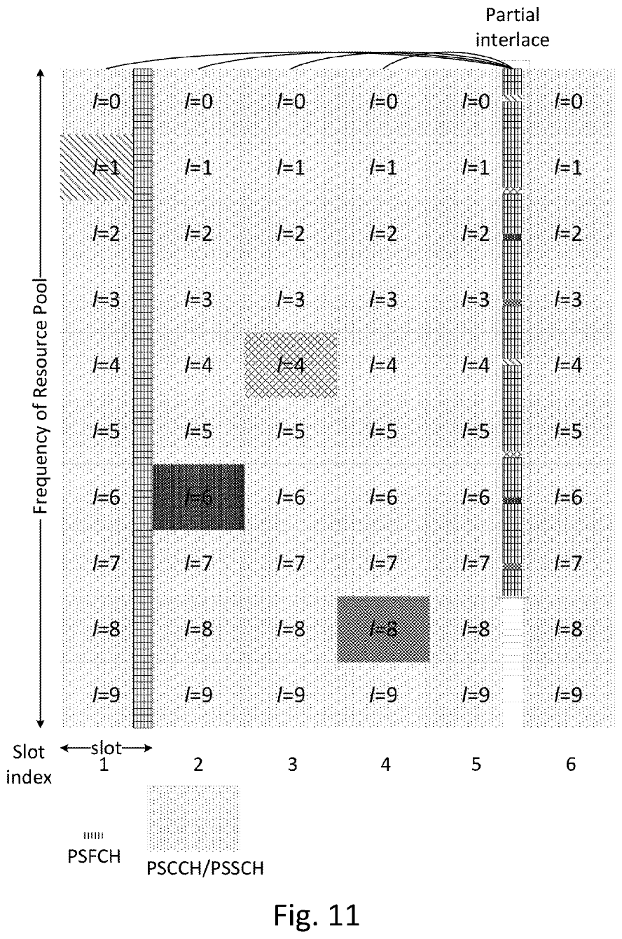

Certain embodiments may provide partial interlace for PSFCH resources with different periods. For example, FIG. 10 illustrates an example embodiment of a partial interlace structure for PSFCH resource period of 2. FIG. 11 illustrates an example embodiment of a partial interlace structure for PSFCH resource period of 4. It can be seen that there would not be enough PSFCH resources available to construct full interlace.

In the example embodiments illustrated in FIGS. 3, 4, 5, 7, 8, 9, 10 and 11, which are provided for purposes of illustration, a PSSCH occupies a sub-channel. A PSSCH can also occupy multiple sub-channels. The designs depicted in the examples noted above can also be similarly applied to the case where a PSSCH occupies multiple sub-channels.

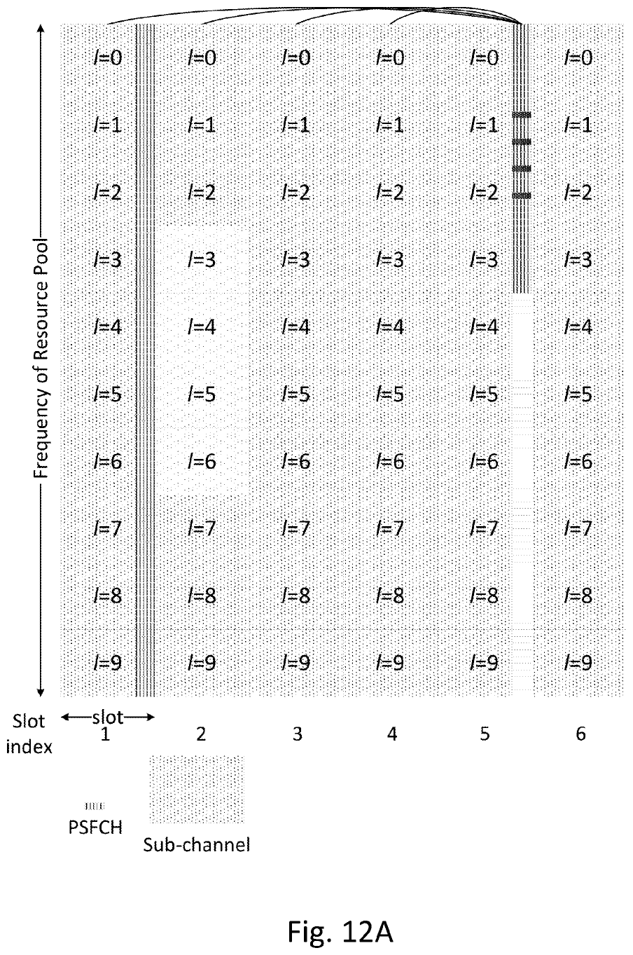

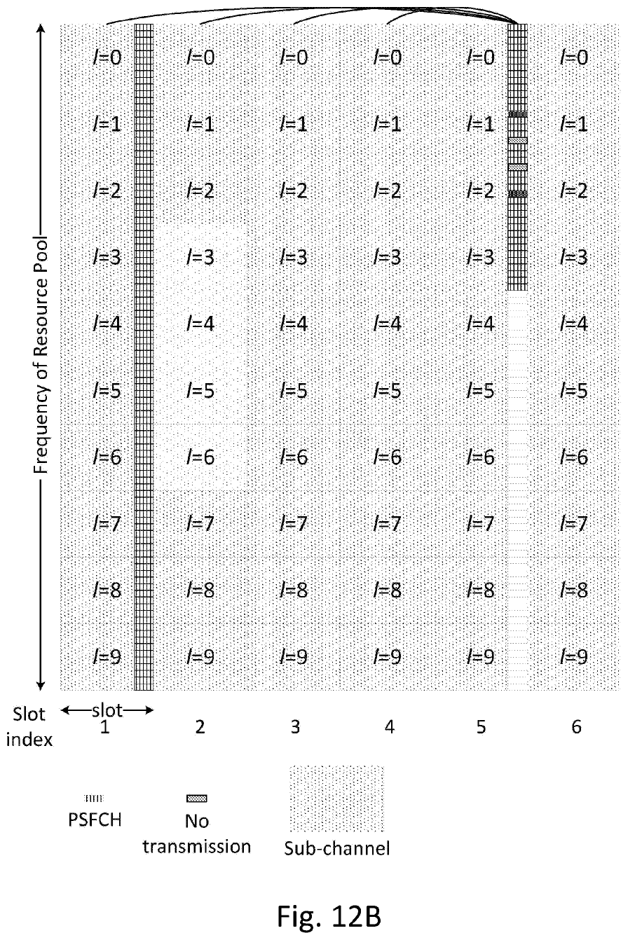

In some embodiments, a receiving UE may transmit PSFCHs on unused PSFCH resources associated with a PSSCH from a transmitting UE. The PSFCHs convey HARQ feedbacks corresponding to PSSCHs from the transmitting UE. In more detail, the PSFCHs can convey the HARQ feedback(s) corresponding to the PSSCH or convey HARQ feedback(s) corresponding to previous PSSCH(s) from the transmitting UE. Unused PSFCH resources can be frequency resources such as PRBs or code resources. For example, in the case with the PSFCH resource period configured as P, for a PSSCH occupying D sub-channels (sub-channel w,w+1, . . . ,w+D−1) in slot p, the corresponding PSFCH resources for transmitting HARQ feedback are PRB_{p-1+w*P}, PRB_{p-1+(w+1)*P}, . . . , PRB_{p-1+(w+D-1)*P} (0<=w<=N/P−1). With current Release-16 specification (the mapping between PSFCH resources and data sub-channels follows Release-16 specification), only part of the PRBs (e.g. PRB_{p-1+w*P}) may be used for transmitting PSFCH(s) conveying the HARQ feedback(s) corresponding to the PSSCH. Other PRBs (e.g. PRB_{p-1+(w+1)*P}, . . . , PRB_{p-1+(w+D-1)*P}) are not used. In sidelink communication in unlicensed spectrum, the other unused PRBs can be exploited to transmit PSFCHs conveying the HARQ feedback(s) corresponding to the PSSCH or conveying HARQ feedbacks corresponding to previous PSSCHs from the transmitting UE. In the example of FIG. 12A, for a PSSCH occupying 4 sub-channels (sub-channel 3,4,5,6) in slot 2, the corresponding PSFCH resources for transmitting HARQ feedback are PRB 13,17,21,25. Only PRB 13 may be used for transmitting PSFCH(s) conveying the HARQ feedback(s) corresponding to the PSSCH. Other PRBs (e.g. PRB 17, 21, 25) are unused PRBs.

In some embodiments, a receiving UE may transmit PSFCHs on unused PSFCH resources associated with a PSSCH from a transmitting UE. The PSFCH transmissions from the receiving UE span at least 2 MHz. The PSFCHs convey HARQ feedbacks corresponding to PSSCHs from the transmitting UE. Out of D PRBs of PSFCH resources associated with the PSSCH, the receiving UE transmits at Q (2≤Q≤D) PRBs that span at least 2 MHz. In the example of FIG. 12B, for a PSSCH occupying 4 sub-channels (sub-channel 3,4,5,6) in slot 2, the corresponding PSFCH resources for transmitting HARQ feedback are PRB 13,17,21,25. The receiving UE transmits at PRB 13 and 25, which span more than 2 MHz.

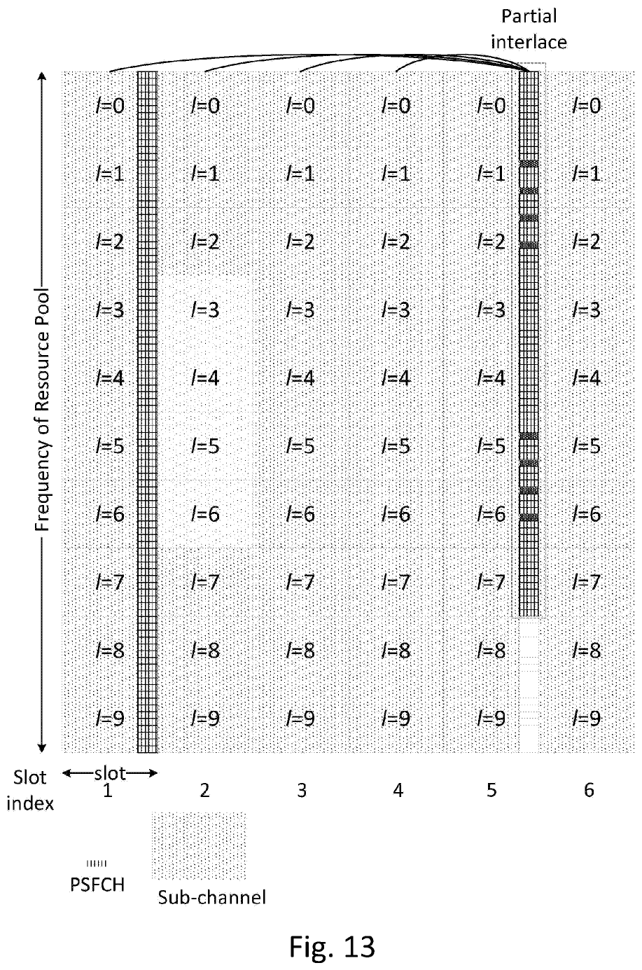

In some embodiments, a receiving UE may transmit PSFCHs on unused PSFCH resources from M PRB clusters. The PSFCH transmissions from the receiving UE span at least 2 MHz. The PSFCHs convey HARQ feedbacks corresponding to PSSCHs from the transmitting UE. Out of D*M PRBs of PSFCH resources, the receiving UE transmits at Q (2≤Q≤D*M) PRBs that span at least 2 MHz. In the example of FIG. 13, out of 8 PRBs of PSFCH resources, the receiving UE transmits at Q (2≤Q≤8) PRBs, which span at least 2 MHz.

The description of the above embodiments focuses on the case with 1 PRB PSFCH resource associated with a sub-channel. However, it is noted that the designs can also be applied to the case with multiple-PRB PSFCH resource associated with a sub-channel similarly.

In the example embodiments discussed above, the parameter K is configured as 1. However, it is noted that the designs can also be applied to any positive integer values of K.

In a sidelink system in licensed spectrum, a sub-channel (minimum granularity of a PSSCH) occupies consecutive PRBs (e.g., 10 PRBs). This is also the case in unlicensed spectrum without OCB requirement.

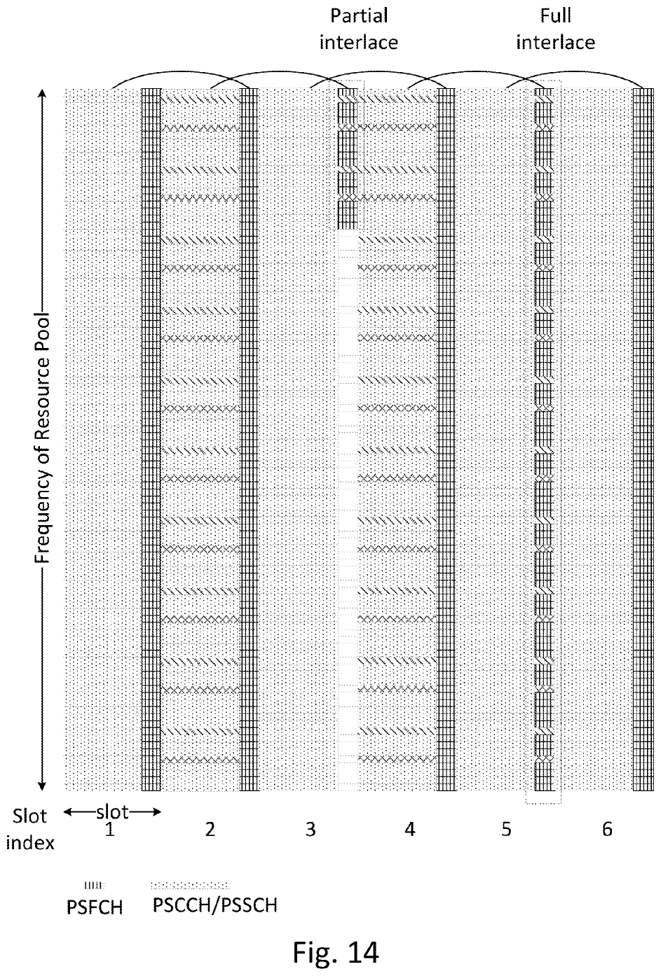

In unlicensed spectrum with OCB requirement, a sub-channel can directly employ interlaced FDM structure adopted for NR-U uplink. However, the mapping between sub-channels and PSFCHs can be kept unchanged. FIG. 14 illustrates an example with sub-channels for PSSCH with interlaced FDM structure and the association between sub-channels and PSFCHs.

Explicit COT defined for NR-U can be applied with the HARQ feedback scheme with partial interlace, as described herein according to certain embodiments. As discussed above, if a Tx UE initiates a COT, the corresponding Rx UE may detect the COT and choose to transmit HARQ feedback with partial interlace structure if the PSFCH symbols are within the COT.

For a sidelink communication system, an implicit COT at the system level may be defined. In the same slot to transmit HARQ feedback in the PSFCH resources, if the Rx UE detects PSCCH/PSSCH transmission (via decoding of PSCCHs) from a Tx UE (not necessarily the corresponding Tx UE) in the same sidelink system, the Rx UE may determine that a COT is established which lasts to the end of the slot. Such implicit COT increases the applicability of proposed partial interlace scheme.

The transmissions of PSCCHs are of broadcast nature and can be decoded by any UE in the sidelink system. Implicit COT loosely meets the COT specification and is fair to external communication systems such as Wi-Fi system.

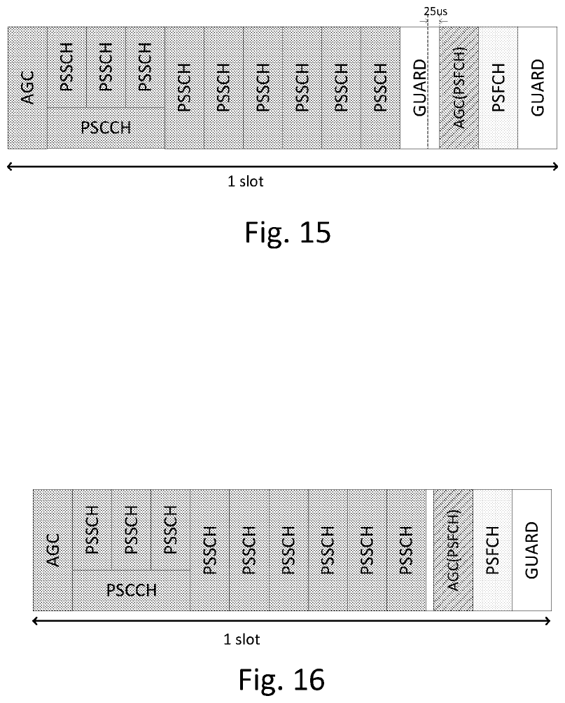

If SL-U reuses the frame structure in licensed spectrum, the guard symbol before PSFCH symbols is longer than 25 us. If a COT is detected, the Rx UE can perform Type 2A LBT (25 us) before PSFCH symbols, as illustrated in the example of FIG. 15.

Further, SL-U can shorten the length of the guard symbol before PSFCH symbols to be less than 16 us, as illustrated in the example of FIG. 16. Then, if a COT is detected, the Rx UE can perform Type 2C LBT (no LBT). Alternatively, the length of the guard symbol is kept unchanged. But the transmission of PSFCH symbols is extended earlier and starts in the middle of the guard symbol, which makes the gap between the transmission of the last PSSCH symbol and the transmission of PSFCH symbols less than 16 us. This can increase the chance for the Rx UE to acquire the channel to transmit HARQ feedback in partial interlace, especially when there are PSSCH transmissions in the same slot.

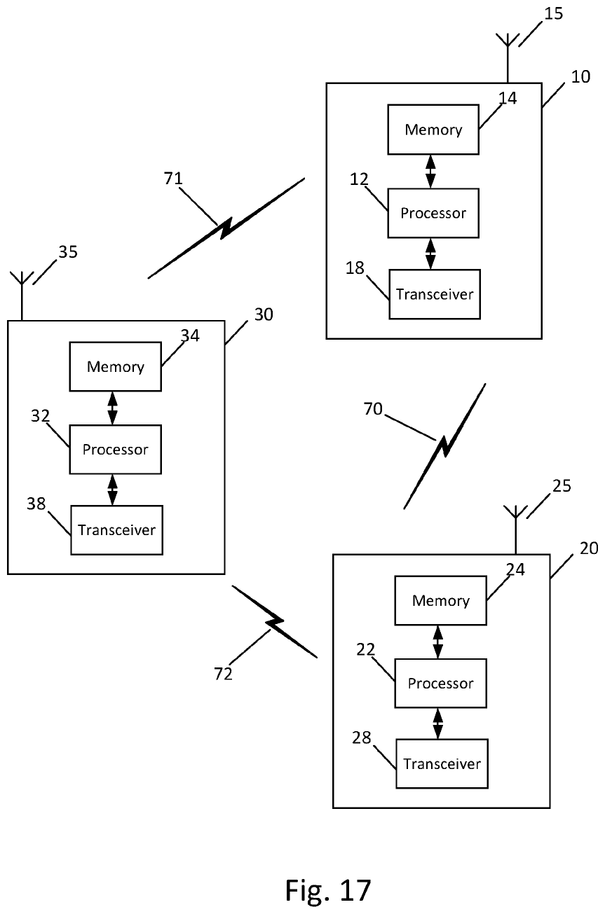

FIG. 17 illustrates an example of an apparatus 10, apparatus 20, and apparatus 30, according to certain example embodiments. In an embodiment, apparatus 10 may be a node, host, or server in a communications network or serving such a network. For example, apparatus 10 may be a UE, mobile equipment (ME), mobile station, mobile device, stationary device, IoT device, TSN device, or other device. As described herein, UE may alternatively be referred to as, for example, a mobile station, mobile equipment, mobile unit, mobile device, user device, subscriber station, wireless terminal, tablet, smart phone, IoT device, sensor or NB-IoT device, or the like. As one example, apparatus 10 may be implemented in, for instance, a wireless handheld device, a wireless plug-in accessory, or the like. It should be noted that one of ordinary skill in the art would understand that apparatus 10 may include components or features not shown in FIG. 17.

As illustrated in the example of FIG. 17, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 17, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources. In certain examples, processor 12 may be configured as a processing means or controlling means for executing any of the procedures described herein.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein. In certain example embodiments, memory 14 may be configured as a storing means for storing any information or instructions for execution as discussed elsewhere herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. In certain example embodiments, transceiver 18 may be configured as a transceiving means for transmitting or receiving information as discussed elsewhere herein. Additionally or alternatively, in some embodiments, apparatus 10 may include an input and/or output device (I/O device) or means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may include a UE (e.g., SL UE), mobile device, mobile station, ME, IoT device and/or NB-IoT device, for example. For example, in some embodiments, apparatus 10 may be configured to perform one or more of the processes depicted in any of the flow charts or signaling diagrams described herein, such as that illustrated in the example of FIG. 17. For instance, in some embodiments, apparatus 10 may be configured to perform one or more of the operations performed by the SL Rx UE as discussed elsewhere herein. In some embodiments, as discussed herein, apparatus 10 may be configured to perform a procedure relating to enhanced PSFCH transmission for SL-U, for instance.

FIG. 17 further illustrates an example of an apparatus 20, according to an embodiment. In an embodiment, apparatus 20 may be a node, host, or server in a communications network or serving such a network. For example, apparatus 20 may be a network node, satellite, base station, a Node B, an evolved Node B (eNB), 5G Node B or access point, next generation Node B (NG-NB or gNB), TRP, HAPS, Remote Radio Head (RRH), integrated access and backhaul (IAB) node, and/or a WLAN access point, associated with a radio access network, such as a LTE network, 5G or NR, or 6G. In some example embodiments, apparatus 20 may be gNB or other similar radio node, for instance.

It should be understood that, in some example embodiments, apparatus 20 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 20 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 20 may include components or features not shown in FIG. 17.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 17.

As illustrated in the example of FIG. 17, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 17, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 or apparatus 30 via a wireless or wired communications link or interface 70 according to any radio access technology, such as NR.

According to some embodiments, processor 22 and memory 24 may be included in or may form a part of processing circuitry/means or control circuitry/means. In addition, in some embodiments, transceiver 28 may be included in or may form a part of transceiving circuitry or transceiving means.

As discussed above, according to some embodiments, apparatus 20 may be or may be a part of a network element or RAN node, such as a base station, access point, Node B, eNB, gNB, TRP, RRH, HAPS, IAB node, relay node, WLAN access point, satellite, or the like. According to certain embodiments, apparatus 20 may be controlled by memory 24 and processor 22 to perform the functions associated with example embodiments described herein. For example, in some embodiments, apparatus 20 may be configured to perform one or more of the processes depicted in any of the flow charts or signaling diagrams described herein. According to an embodiment, apparatus 20 may be configured to perform a procedure relating to enhanced PSFCH transmission for SL-U, for instance.

FIG. 17 further illustrates an example of an apparatus 30, according to an example embodiment. In an example embodiment, apparatus 30 may be a node or element in a communications network or associated with such a network, such as a UE, mobile equipment (ME), mobile station, mobile device, stationary device, IoT device, TSN device, or other device. As described herein, UE may alternatively be referred to as, for example, a mobile station, mobile equipment, mobile unit, mobile device, user device, subscriber station, wireless terminal, tablet, smart phone, IoT device or NB-IoT device, a connected car, or the like. As one example, apparatus 30 may be implemented in, for instance, a wireless handheld device, a wireless plug-in accessory, or the like.

In some example embodiments, apparatus 30 may include one or more processors, one or more computer-readable storage medium (for example, memory, storage, or the like), one or more radio access components (for example, a modem, a transceiver, or the like), and/or a user interface. In some example embodiments, apparatus 30 may be configured to operate using one or more radio access technologies, such as GSM, LTE, LTE-A, NR, 5G, WLAN, WiFi, NB-IoT, MulteFire, and/or any other radio access technologies. It should be noted that one of ordinary skill in the art would understand that apparatus 30 may include components or features not shown in FIG. 17.

As illustrated in the example of FIG. 17, apparatus 30 may include or be coupled to a processor 32 for processing information and executing instructions or operations. Processor 32 may be any type of general or specific purpose processor. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 32 is shown in FIG. 17, multiple processors may be utilized according to other example embodiments. For example, it should be understood that, in certain example embodiments, apparatus 30 may include two or more processors that may form a multiprocessor system (e.g., in this case processor 32 may represent a multiprocessor) that may support multiprocessing. In certain example embodiments, the multiprocessor system may be tightly coupled or loosely coupled (e.g., to form a computer cluster).

Processor 32 may perform functions associated with the operation of apparatus 30 including, as some examples, precoding of antenna gain/phase parameters, encoding and decoding of individual bits forming a communication message, formatting of information, and overall control of the apparatus 30, including processes related to management of communication resources.

Apparatus 30 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 34 can be comprised of any combination of random access memory (RAM), read only memory (ROM), static storage such as a magnetic or optical disk, hard disk drive (HDD), or any other type of non-transitory machine or computer readable media. The instructions stored in memory 34 may include program instructions or computer program code that, when executed by processor 32, enable the apparatus 30 to perform tasks as described herein.

In an example embodiment, apparatus 30 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 32 and/or apparatus 30.

In some example embodiments, apparatus 30 may also include or be coupled to one or more antennas 35 for receiving a downlink signal and for transmitting via an uplink from apparatus 30. Apparatus 30 may further include a transceiver 38 configured to transmit and receive information. The transceiver 38 may also include a radio interface (e.g., a modem) coupled to the antenna 35. The radio interface may correspond to a plurality of radio access technologies including one or more of GSM, LTE, LTE-A, 5G, NR, WLAN, NB-IoT, BT-LE, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 38 may be configured to modulate information on to a carrier waveform for transmission by the antenna(s) 35 and demodulate information received via the antenna(s) 35 for further processing by other elements of apparatus 30. In other example embodiments, transceiver 38 may be capable of transmitting and receiving signals or data directly. Additionally or alternatively, in some example embodiments, apparatus 30 may include an input and/or output device (I/O device). In certain example embodiments, apparatus 30 may further include a user interface, such as a graphical user interface or touchscreen.

In an example embodiment, memory 34 stores software modules that provide functionality when executed by processor 32. The modules may include, for example, an operating system that provides operating system functionality for apparatus 30. The memory may also store one or more functional modules, such as an application or program, to provide additional functionality for apparatus 30. The components of apparatus 30 may be implemented in hardware, or as any suitable combination of hardware and software. According to an example embodiment, apparatus 30 may optionally be configured to communicate with apparatus 10 via a wireless or wired communications link 71 and/or to communicate with apparatus 20 via a wireless or wired communications link 72, according to any radio access technology, such as NR.

According to some example embodiments, processor 32 and memory 34 may be included in or may form a part of processing circuitry or control circuitry. In addition, in some example embodiments, transceiver 38 may be included in or may form a part of transceiving circuitry.

As discussed above, according to some example embodiments, apparatus 30 may be a UE (e.g., SL UE), mobile device, mobile station, ME, IoT device, TSN device and/or NB-IoT device, for example. According to certain example embodiments, apparatus 30 may be controlled by memory 34 and processor 32 to perform the functions associated with example embodiments described herein. For instance, in some example embodiments, apparatus 30 may be configured to perform one or more of the processes depicted in any of the diagrams or signaling flow diagrams described herein. As an example, apparatus 30 may correspond to or represent a SL Tx UE. According to certain example embodiments, apparatus 30 may be configured to perform a procedure relating to enhanced PSFCH transmission for SL-U, for instance.

In some example embodiments, an apparatus (e.g., apparatus 10 and/or apparatus 20 and/or apparatus 30) may include means for performing a method, a process, or any of the variants discussed herein. Examples of the means may include one or more processors, memory, controllers, transmitters, receivers, sensors, circuits, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, certain example embodiments can improve and enhance at least NR SL HARQ feedback in an unlicensed carrier. For example, some embodiments can enhance NR SL HARQ feedback in a manner that meets OCB requirements. Furthermore, certain embodiments can ensure that PSFCH transmissions meet OCB requirements in a resource efficient manner, and can increase reliability of HARQ feedback by reducing mutual interference. As a result, example embodiments can reduce, for instance, signaling, latency and/or power consumption. Accordingly, the use of certain example embodiments results in improved functioning of communications networks and their nodes, such as base stations, eNBs, gNBs, and/or IoT devices, UEs or mobile stations, or the like.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, some functionality of example embodiments may be implemented as a signal that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Some embodiments described herein may use the conjunction “and/or”. It should be noted that, when used, the term “and/or” is intended to include either of the alternatives or both of the alternatives, depending on the example embodiment or implementation. In other words, “and/or” can refer to one or the other or both, or any one or more or all, of the things or options in connection with which the conjunction is used.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### Partial Glossary

ACK acknowledge
COT channel occupancy time
FDM frequency division multiplexing
HARQ hybrid acknowledge request
NACK not acknowledge
NR-U new radio unlicensed
OCB occupied channel bandwidth
PRB physical resource block
PSCCH physical sidelink control channel
PSD power spectral density
PSFCH physical sidelink feedback channel
PSSCH physical sidelink shared channel
Rx receiver
SCS subcarrier spacing
SL-U sidelink unlicensed
Tx transmitter.

1-15. (canceled)

16. An apparatus, comprising:
at least one processor; and
at least one memory comprising computer program code,
the at least one memory and computer program code configured, with the at least one processor, to cause the apparatus at least to:
decode a physical sidelink shared channel (PSSCH);
determine a physical sidelink feedback channel (PSFCH) resource for hybrid automatic repeat request (HARQ) feedback to the physical sidelink shared channel (PSSCH); and
determine whether to transmit the hybrid automatic repeat request (HARQ) feedback with partial interlace or with full interlace based at least on whether channel occupancy time (COT) sharing is detected from a transmitting user equipment.

17. The apparatus of claim 16, wherein, to determine whether to transmit the hybrid automatic repeat request (HARQ) feedback with partial interlace or with full interlace, the at least one memory and computer program code are configured, with the at least one processor, to cause the apparatus at least to:
detect that the channel occupancy time (COT) is shared from the transmitting user equipment (UE) and the physical sidelink feedback channel (PSFCH) resource is within the channel occupancy time (COT); and
transmit the hybrid automatic repeat request (HARQ) feedback with partial interlace.

18. The apparatus of claim 16, wherein, to determine whether to transmit the hybrid automatic repeat request (HARQ) feedback with partial interlace or with full interlace, the at least one memory and computer program code are configured, with the at least one processor, to cause the apparatus at least to:
detect that the channel occupancy time (COT) is not shared from the transmitting user equipment (UE); and
decide not to transmit on the physical sidelink feedback channel (PSFCH) resource.

19. The apparatus of claim 16, wherein, to determine whether to transmit the hybrid automatic repeat request (HARQ) feedback with partial interlace or with full interlace, the at least one memory and computer program code are configured, with the at least one processor, to cause the apparatus at least to:
detect that the channel occupancy time (COT) is not shared from the transmitting user equipment (UE); and
transmit the hybrid automatic repeat request (HARQ) feedback with full interlace.

20. The apparatus of claim 19, wherein the hybrid automatic repeat request (HARQ) feedback comprises no acknowledgement (NACK).

21. The apparatus of claim 20, wherein the at least one memory and computer program code are configured, with the at least one processor, to cause the apparatus at least to:
perform type 1 listen before talk (LBT); and
when the type 1 listen before talk (LBT) succeeds, transmit the no acknowledgement (NACK) with full interlace.

22. The apparatus of claim 18, wherein, when it is decided not to transmit on the physical sidelink feedback channel (PSFCH) resource,
the hybrid automatic repeat request (HARQ) feedback is transmitted via additional physical sidelink feedback channel (PSFCH) occasions, or
the hybrid automatic repeat request (HARQ) feedback is piggy backed with a physical sidelink shared channel (PSSCH) to the transmitting user equipment (UE) via medium access control (MAC) control element (CE).

23. The apparatus of claim 17, wherein, to transmit the hybrid automatic repeat request (HARQ) feedback with partial interlace, the at least one memory and computer program code are configured, with the at least one processor, to cause the apparatus at least to:
transmit the hybrid automatic repeat request (HARQ) feedback with partial interlace at a fixed number of interlaced physical resource blocks.

24. The apparatus of claim 23, wherein, to transmit the hybrid automatic repeat request (HARQ) feedback with partial interlace at the fixed number of interlaced physical resource blocks, the at least one memory and computer program code are configured, with the at least one processor, to cause the apparatus at least to:
transmit at M interlaced physical resource blocks that span at least 2 MHz, wherein M≥2.

25. The apparatus of claim 17, wherein, to transmit the hybrid automatic repeat request (HARQ) feedback with partial interlace, the at least one memory and computer program code are configured, with the at least one processor, to cause the apparatus at least to:
transmit the hybrid automatic repeat request (HARQ) feedback with partial interlace at an adaptive number of interlaced physical resource blocks.

26. The apparatus of claim 25, wherein, to transmit the hybrid automatic repeat request (HARQ) feedback with partial interlace at an adaptive number of interlaced physical resource blocks, the at least one memory and computer program code are configured, with the at least one processor, to cause the apparatus at least to:
transmit at Q interlaced physical resource blocks that span at least 2 MHz, wherein 2≤Q≤M, wherein M is a total number of interlaced physical resource blocks.

27. The apparatus of claim 17, wherein, to transmit the hybrid automatic repeat request (HARQ) feedback with partial interlace, the at least one memory and computer program code are configured, with the at least one processor, to cause the apparatus at least to:
when a bandwidth spanned by transmissions at two physical resource blocks is smaller than 2 MHz, insert an empty physical resource block between the two physical resource blocks.

28. The apparatus of claim 17, wherein, to detect that the channel occupancy time (COT) is shared, the at least one memory and computer program code are configured, with the at least one processor, to cause the apparatus at least to:
detect at least one of physical sidelink control channel (PSCCH) or physical sidelink shared channel (PSSCH) transmission from the transmitting user equipment (UE) or from another transmitting user equipment (UE) in a same sidelink system; and
based on the detecting, determine that implicit channel occupancy time (COT) is established.

29. An apparatus, comprising:
at least one processor; and
at least one memory comprising computer program code,
the at least one memory and computer program code configured, with the at least one processor, to cause the apparatus at least to:
decode a physical sidelink shared channel (PSSCH);
determine unused physical sidelink feedback channel (PSFCH) resources associated with the physical sidelink shared channel (PSSCH);
transmit physical sidelink feedback channels (PSFCHs) on the unused physical sidelink feedback channel (PSFCH) resources;
wherein the physical sidelink feedback channels (PSFCHs) convey hybrid automatic repeat request (HARQ) feedback to the physical sidelink shared channel (PSSCH) or convey hybrid automatic repeat request (HARQ) feedbacks to previous physical sidelink shared channels (PSSCHs) from a transmitting user equipment.

30. An apparatus, comprising:
at least one processor; and
at least one memory comprising computer program code,
the at least one memory and computer program code configured, with the at least one processor, to cause the apparatus at least to:
decode a physical sidelink shared channel (PSSCH) occupying multiple sub-channels;
determine D physical resource blocks of physical sidelink feedback channel (PSFCH) resources associated with the physical sidelink shared channel (PSSCH); and
transmit at Q physical resource blocks that span at least 2 MHz, wherein 2≤Q≤D.

31-46. (canceled)
